(19) United States
(12) Patent Application Publication
(10) Pub. No.: US 2024/0274948 A1
(43) Pub. Date: Aug. 15, 2024

(54) Absorber Structure for High-Voltage Stores, Energy Storage Arrangement, Energy Store Housing, and Process for Manufacturing an Absorber Structure

(71) Applicant: Bayerische Motoren Werke AKtiengesellschaft, Muenchen (DE)

(72) Inventors: Sandro CIFALDI, Muenchen (DE); Jan PAULUS, Miesbach (DE)

(21) Appl. No.: 18/566,816

(22) PCT Filed: Jul. 12, 2022
(86) PCT No.: PCT/EP2022/069385

§ 371 Date: Dec. 4, 2023

(30) Foreign Application Priority Data
Aug. 4, 2021 (DE) 10 2021 120 234.5

(51) Int. Cl. H01M 50/242; H01M 50/213; H01M 50/222; H01M 50/227; H01M 50/24; H01M 50/30

(52) U.S. Cl. CPC H01M 50/242; H01M 50/213; H01M 50/222; H01M 50/227; H01M 50/24; H01M 50/394

(57) ABSTRACT

An absorber structure for high-voltage energy stores has a main part, an upper face of which includes a placement area designed to place a multiplicity of energy storage cells thereon. The main part is in the form of a plastic part, in particular a foam part. The main part is provided with an additional element made of fiber material designed to afford a shielding or protective effect to the upper face.

### BACKGROUND AND SUMMARY

The present invention relates to an absorber structure for high-voltage stores, to an energy storage arrangement, to an energy store housing and to a method for producing an absorber structure for energy store housings.

Nowadays, motor vehicles that are powered partially electrically and fully electrically have very large energy store housings, in which the energy storage cells/batteries are accommodated. In passenger cars, such store housings often occupy a large region of the underbody. For safety reasons, the energy storage cells have to be protected, in particular from below, against mechanical actions. In this context, DE 10 2019 132 026 A1 discloses a battery carrier for a battery of a motor vehicle, comprising a trough-like receiving space for the battery, said receiving space being delimited by a lateral frame and a base, wherein, in the intended installation position of the battery carrier in the motor vehicle, a base outer side of the base points downward and a base inner side of the base points upward, and wherein at least one reinforcing plate having a plurality of material cutouts is arranged on the base inner side and is connected to the base inner side in a shear-resistant manner. The use of such reinforcing plates is not unproblematic, since the weight of the overall arrangement is increased. In addition, it is necessary to ensure that in an energy storage cell a targeted pressure reduction or a degassing is also possible through such a reinforcing plate in the event of a defect.

According to the invention, an absorber structure for high-voltage stores comprises a main body which has, on an upper side, an arrangement surface which is designed for arrangement of a multiplicity of energy storage cells, wherein the main body is in the form of a plastics body, in particular in the form of a foam body, and wherein the main body has an additional element which comprises fiber material and which is designed to provide a shielding or protective action with respect to the upper side. The absorber structure is used for the, in particular materially bonded, connection, for example by means of adhesive, of a multiplicity of energy storage cells. The energy storage cells, in the present case for example round cells, are preferably arranged upright and next to one another. This results in intermediate spaces between the energy storage cells. In the event of an exothermic cell reaction, there is the risk of conductive particles which escape from a damaged cell, such as copper and soot particles, passing into these cell intermediate spaces. This can result in short-circuit reactions which entail devastating consequences. A plastics body/foam body makes it possible to realize excellent properties in terms of the crash behavior. The weight can also be kept low. However, in the event of a high temperature increase, there is the risk of the plastics body/foam body being damaged. The additional element is then advantageously present and is designed to provide an, in particular, electrical and/or mechanical shielding or protective action with respect to the upper side. Any particles flung in the direction of the upper side are advantageously retained or arrested by the additional element.

According to a preferred embodiment, the plastics body is formed from a porous or foamed material. Such a configuration is lightweight, stiff and able to absorb a lot of energy if for example an accident were to occur. The plastics body may be formed from composite material. The plastics body may also comprise metallic constituents. According to a preferred embodiment, the plastics body is a foam body. The term “foam body” will primarily be used below without limiting the generality.

According to one embodiment, the main body or foam body has a thickness of for example 5-45 mm, particularly preferably a thickness of approximately 10-30 mm. The main body has an upper side and a lower side, wherein the arrangement surface is expediently formed on the upper side. The main body and the arrangement surface expediently extend in one plane, the plane preferably extending parallel to a roadway plane in the intended installation position of the absorber structure. However, this is not absolutely necessary, particularly if for example an absorber structure, used in an energy store housing, is concerned which is used in a motorcycle.

Expediently, the additional element comprises or is formed from heat-resistant or temperature-resistant material which is in particular non-flammable or only has low flammability.

The aforementioned properties can advantageously be provided by way of the fiber material.

In the present case, fiber material means in particular a nonwoven, nonwoven material, a laid scrim, woven fabric, a woven fabric material and/or a fiber mat/fiberboard. Fiber material is advantageously distinguished by its mechanical properties, which are well suited to providing the protective action desired in the present case. According to one embodiment, the additional element also comprises matrix material in addition to the fiber material. In the present case, a preferred fiber material is glass fiber. The material is inexpensive and exhibits suitable properties for the present purpose.

According to a preferred embodiment, the additional element is an organosheet or a (glass) fiber mat/(glass) fiberboard. Organosheets are fiber composite materials. In particular, they are fiber-matrix semifinished products. They consist of a woven fiber fabric or a laid fiber scrim which is embedded into a thermoplastic, or alternatively thermosetting, plastics matrix. The fiber mat/fiberboard may or may not comprise matrix material.

According to a preferred embodiment, the additional element forms the arrangement surface. According to a preferred embodiment, the absorber structure has a main body which is formed from foam, the arrangement surface thereof, which is provided for arrangement of the energy storage cells, being formed by the additional element, thus by an organosheet or a fiber mat/fiberboard according to a preferred embodiment.

According to a preferred embodiment, the fiber material used in the additional element comprises inorganic fibers or is based on inorganic fibers. According to a preferred embodiment, the additional element is configured to have low flammability or to be non-combustible. This can be readily realized using inorganic materials. In particular, the additional element comprises at least materials or constituents which are configured to have low flammability or to be non-combustible. This is intended to ensure that the additional element as such persists at temperatures up to 1000° C. and more.

According to one embodiment, the additional element is configured to be permeable to gas at least in certain regions. To this end, the additional element has one or more openings and/or apertures which are designed to be flowed through by a fluid. According to one embodiment, the additional element is configured to be permeable to gas in the region of the ventilation openings (described in more detail below), comprising for example one or more openings.

The fiber material, in particular if it is not permeated with matrix material, as such advantageously already exhibits gas permeability, with the result that the introduction of apertures/openings can possibly be omitted.

Expediently, the openings/apertures or the fiber material itself act as a throttle which advantageously brings about a pressure reduction in the case of a thermal event.

The use of the fiber material in particular also entails the advantage that it can act as a predetermined breaking point. The additional element is thus expediently designed or formed so as to fail locally in the case of a sudden temperature increase. Here, “fail” in particular means that one or more holes/perforations, via which pressure can escape, can be produced in the additional element. In this case, the aforementioned holes expediently act as a throttle. This throttle function already makes it possible to realize a first pressure reduction. However, due to the heat resistance or temperature resistance, the additional element as such retains its shape.

According to a preferred embodiment, the foam body is formed from an expanded plastic which is foamed or formed onto the additional element. According to a preferred embodiment, the material for the foam body is an expanded polypropylene (EPP). Alternative materials are also advantageously usable. The additional element is thus expediently fastened during the production of the main body. In this case, the additional element may expediently form a connection directly with the EPP foam.

According to one embodiment, the preferably inorganic-based fiber material, such as a (glass) fiber mat/fiberboard or a textile comprising fibers, etc., is connected in the tool directly to the material of the main body, such as the EPP foam. In this case, it may also be at least partially impregnated or infiltrated during the production of the main body, such as during the EPP foaming process. According to one embodiment, an organosheet (composite of polypropylene and glass fiber) is connected in the tool directly to the EPP foam during the EPP foaming process.

According to one embodiment, the main body has ventilation openings which extend away from the arrangement surface, wherein the additional element covers the ventilation openings in the direction of the energy storage cells. The ventilation openings are expediently arranged in the extension of the energy storage cells.

According to one embodiment, the ventilation openings extend perpendicularly or substantially perpendicularly with respect to the aforementioned plane. As an alternative or in addition, at least one or a plurality of ventilation openings may also be formed in an oblique or inclined manner with respect to the plane. In particular, the ventilation openings enable a flow path or air path which is directed away from the energy storage cells arranged on the main body. The ventilation openings preferably extend as far as the additional element, which directly forms the arrangement surface according to a preferred embodiment.

A main body comprising the aforementioned ventilation openings may also be referred to as honeycomb-shaped.

The main body may also be configured to be closed toward the upper side. Correspondingly, the ventilation openings are not of continuous form. The honeycomb shape as such remains unchanged. According to one embodiment, the upper side of the main body is formed by a for example 2-5 mm thick layer of the main body. In the case of a thermal event in an energy storage cell, such a thin layer of the main body is pierced on account of the rapid and high pressure increase. According to one embodiment, the additional element is arranged/formed on the aforementioned layer.

In principle, the additional element is formed on the upper side of the main body according to a preferred embodiment, it being able to directly form the arrangement surface there. However, as an alternative, it may also be expedient for the additional element to be formed as a kind of intermediate layer within the main body. One embodiment also makes provision for arrangement of a plurality of additional elements, preferably one above the other and for example spaced apart from one another.

The main body is expediently formed in such a way that an exchange of gas is also made possible in a transverse direction. It is thus possible to effectively realize a pressure reduction. To this end, according to one embodiment, connecting channels which connect the ventilation openings in a fluid-conducting manner are provided in the region of the lower side of the main body. According to one embodiment, the connecting channels are oriented parallel to the aforementioned plane of the main body, wherein they are expediently able to occupy different directions in the plane.

As already mentioned, the energy storage cells are round cells according to a preferred embodiment. However, as an alternative, it is also possible for prismatic cells or cells of a different shape to be concerned. Preference is given to energy storage cells whose degassing valves are oriented toward the absorber structure.

In this case, preferred energy storage cells are in particular lithium-ion cells. It should, however, be expressly mentioned that preferred energy storage cells are not limited to this type of cell. Energy storage cells of the type being discussed may, for example, also be supercapacitors.

The invention also relates to an energy storage arrangement comprising an absorber structure according to the invention, wherein a multiplicity of energy storage cells are arranged on the arrangement surface of the absorber structure.

The arrangement surface is preferably formed by the additional element. The arrangement/fastening of the energy storage cells on/to the arrangement surface or on/to the additional element is preferably effected in a materially bonded manner, for example by means of adhesive bonding.

According to a preferred embodiment, the energy storage cells are round cells which are arranged on the arrangement surface so as to be upright and to extend along a vertical direction, wherein the ventilation openings are each formed in the extension of the energy storage cells. This enables an effective pressure reduction, in particular in the case of a thermal event. The ventilation openings expediently extend along and/or obliquely or transversely with respect to the aforementioned vertical direction.

The main body extends substantially along a plane. In the intended installation state of the main body, the aforementioned plane is oriented substantially parallel to the roadway plane. This applies in particular when used in passenger cars, for example. When used in motorcycles, the installation position can be completely different.

According to one embodiment, the main body is formed such that ventilation is provided in the transverse direction, that is to say within the plane.

The invention is also directed to a method for producing an absorber structure for energy store housings, comprising the steps of:
producing a main body from plastic, in particular from foam;
arranging an additional element, comprising fiber material, in or on the main body, in particular during or in the course of the production of the main body.

The advantages and features mentioned in connection with the absorber structure, the energy storage arrangement and the energy store housing apply analogously to the method, and vice versa as well as in combination.

The proposed method advantageously makes it possible to provide an absorber structure which allows adjacent cells to be protected effectively. The absorber structure entails an improved recyclability, on account of the low number of similar material composites. In the present case, the component production process step for welding the EPP beads is expediently simultaneously used for connection to the additional element, for example to the glass fiber textile or to the organosheet.

The use of fiber materials for the additional element additionally advantageously enables effective adaptation of the mechanical properties of the absorber structure, since the stiffness and strength of the additional element and thus of the overall absorber structure can be set in a targeted manner by way of the fiber materials used, and also the matrix used.

### BRIEF DESCRIPTION OF THE DRAWINGS

FIG. 1 is a schematic sectional view of an energy storage arrangement;

FIG. 2 illustrates the arrangement known substantially from FIG. 1, an arrangement surface of the main body having a coating;

FIG. 3 shows one embodiment of an absorber structure as seen from below, together with a detail view; and

FIG. 4 is a schematic partial view of one embodiment of an energy store housing.

### DETAILED DESCRIPTION OF THE DRAWINGS

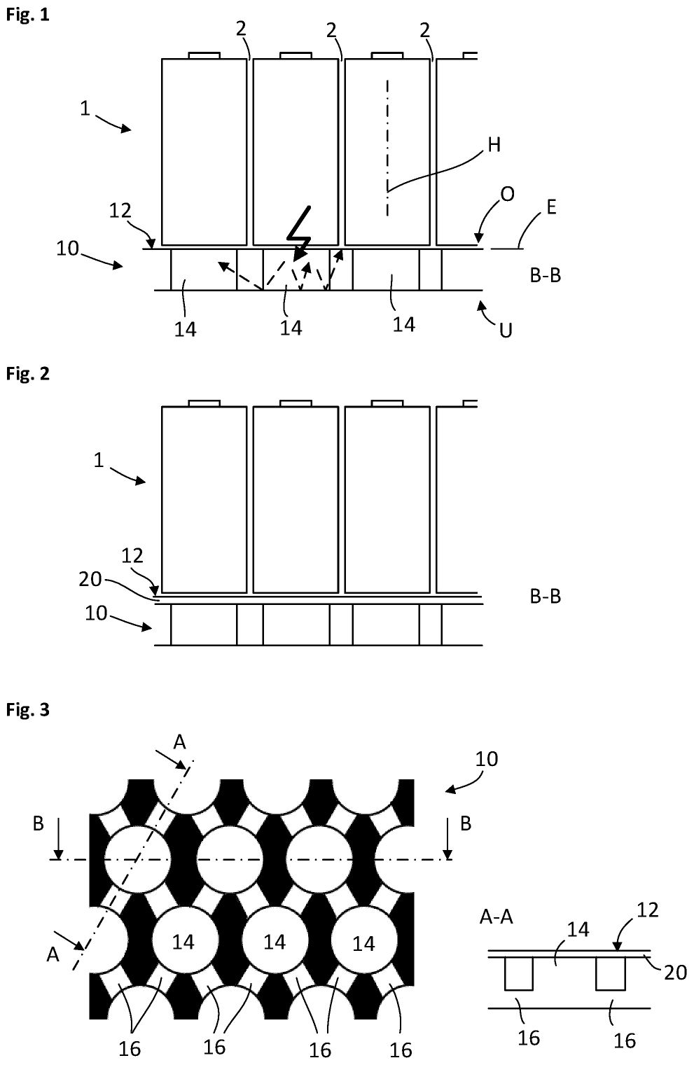

FIG. 1 schematically shows one embodiment of an energy storage arrangement in section, comprising an absorber structure which has a main body 10, wherein a multiplicity of energy storage cells 1, which in the present case are in particular in the form of round cells, are arranged upright on an upper side O of the main body 10. Intermediate spaces 2 are formed between the energy storage cells 1. The energy storage cells or the round cells 1 each extend along a vertical axis H, which in turn extends perpendicularly with respect to a plane E along which the main body 10 is oriented.

According to a preferred embodiment, the main body 10, as depicted in the present case, is in the form of a foam body. Reference designation 14 denotes a plurality of ventilation openings which are in the form for example of continuous openings or apertures within the main body 10. In the present case, the ventilation openings 14 are formed in particular in the extension direction of the energy storage cells 1. Analogously, no ventilation openings 14 are formed in the extension direction of the intermediate spaces 2 between the energy storage cells 1. In other words, the material of the main body 10 lies here. In the present case, the absorber structure is of honeycomb-shaped form. As illustrated here, an absorber structure is arranged on or fastened to a lower housing part of an energy store housing for example by way of its lower side U, preferably in a materially bonded manner.

As schematically depicted by the jagged arrow, in the case of a thermal event in the second energy storage cell 1 from the left, a sudden temperature and pressure increase occurs below the cell 1. The degassing valve of the energy storage cells 1 is formed on their lower side, that is to say is oriented toward the absorber structure. In the case of such an explosion/thermal event, substances/particles from the respective cell are flung downward in the direction of the housing lower part (not depicted here), where they for example ricochet and are flung back in the direction of the other energy storage cells 1. This is also depicted by way of corresponding arrows. If such particles pass for example into the intermediate spaces 2, a short circuit between the cells 1 may occur with correspondingly devastating consequences.

FIG. 2 shows the arrangement known substantially from FIG. 1, wherein in the present case an additional element 20 is provided or arranged on an arrangement surface 12. It can be seen in connection with FIG. 1 that the additional element 20 can act as a stop or barrier in order to shield the energy storage cells 1, and also the intermediate spaces 2, if particles were to escape, as depicted in FIG. 1.

FIG. 3 shows one embodiment of a honeycomb-shaped main body 10 from below. It is possible to see a multiplicity of ventilation openings 14 which extend through the main body 10, preferably in the direction of the energy storage cells (cf. also FIGS. 1 and 2 in this regard). The ventilation openings 14 are preferably connected via a multiplicity of connecting channels 16. For reasons of clarity, not all of the ventilation openings and ventilation channels are provided with a reference designation. For better orientation, a section B-B is depicted in the present case. The section B-B is illustrated, as it were, in FIGS. 1 and 2. A section A-A is also depicted, which is emphasized in the right half of FIG. 3. It is possible to see how the ventilation openings 14 are connected via the connecting channels 16 on the lower side of the absorber structure or of the main body 10. It is also illustrated that the arrangement surface 12 is formed by way of the additional element 20. In the case of a thermal event, the additional element 20 is, for example, pierced locally in the respective region as a result of the high pressure increase.

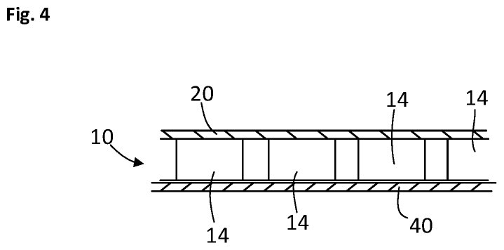

FIG. 4 shows a schematic view of a portion of one embodiment of an energy store housing, wherein a housing of the energy store housing, in particular a housing lower part, is depicted with the reference designation 40. The main body 10 of the absorber structure is expediently fastened thereto in a materially bonded manner, preferably by means of adhesive. The absorber structure or the main body 10 has an additional element 20 on its upper side. This additional element 20 has advantageously already been formed or applied, in particular applied by foaming in the case of the foam body, during the production of the main body itself, the latter preferably being a foam body.

### LIST OF REFERENCE DESIGNATIONS

1 Energy storage cell, round cell
2 Intermediate space, gap
10 Main body
12 Arrangement surface
14 Ventilation opening
16 Connecting channel
20 Coating
40 Housing
O Upper side
U Lower side
H Vertical direction
E Plane

1.-13. (canceled)

14. An absorber structure for high-voltage stores, comprising:
a main body which has, on an upper side, an arrangement surface configured for arrangement of a multiplicity of energy storage cells,
wherein the main body is a plastics body, and
wherein the main body comprises an additional element made of fiber material and which is configured to provide a shielding or protective action with respect to the upper side.

15. The absorber structure according to claim 14, wherein
the plastics body is a foam body.

16. The absorber structure according to claim 14, wherein
the additional element is an organosheet or a glass fiber mat.

17. The absorber structure according to claim 14, wherein
the additional element forms the arrangement surface.

18. The absorber structure according to claim 14, wherein
the fiber material comprises inorganic fibers.

19. The absorber structure according to claim 14, wherein
the additional element is configured to have low flammability or to be non-combustible.

20. The absorber structure according to claim 14, wherein
the additional element is configured to be permeable to gas at least in certain regions.

21. The absorber structure according to claim 14, wherein
the plastics body is formed from an expanded plastic which is foamed or formed onto the additional element.

22. The absorber structure according to claim 14, wherein
the main body comprises ventilation openings which extend away from the arrangement surface, and
the additional element covers the ventilation openings in the direction of the energy storage cells.

23. An energy storage arrangement, comprising:
an absorber structure according to claim 14; and
the multiplicity of energy storage cells arranged on the arrangement surface of the absorber structure.

24. The absorber structure according to claim 23, wherein
the main body comprises ventilation openings which extend away from the arrangement surface,
the additional element covers the ventilation openings in the direction of the energy storage cells,
the energy storage cells are round cells which are arranged on the arrangement surface so as to be upright and to extend along a vertical direction, and
the ventilation openings are each formed in the extension direction of the energy storage cells.

25. The energy storage arrangement according to claim 24, wherein
the main body is formed such that ventilation is provided in a transverse direction.

26. The energy store arrangement according to claim 23, further comprising:
a housing to which the absorber structure is fastened.

27. A method for producing an absorber structure for an energy store housing, the method comprising the steps of:
producing a main body from plastic, the main body having, on an upper side, an arrangement surface configured for arrangement of a multiplicity of energy storage cells,
arranging an additional element made of fiber material, in or on the main body, the additional element providing a shielding or protective action with respect to the upper side.
